(19) United States
(12) Patent Application Publication
(10) Pub. No.: US 2023/0263187 A1
(43) Pub. Date: Aug. 24, 2023

(54) VEGETARIAN HAMBURGER

(71) Applicant: DSM IP ASSETS B.V., Heerlen (NL)

(72) Inventors: Ya-Hui CHIEN, Echt (NL); Stephanie Cecile Caroline AVRIL, Echt (NL)

(21) Appl. No.: 18/020,274

(22) PCT Filed: Jul. 22, 2021
(86) PCT No.: PCT/EP2021/070619

§ 371 Date: Feb. 8, 2023

(30) Foreign Application Priority Data
Aug. 10, 2020 (EP) 20190190.7

(51) Int. Cl. A23J 3/22; A23J 3/16; A23L 29/269; A23L 33/105; A23L 33/115; A23L 33/145; A23L 33/16; A23L 33/15

(52) U.S. Cl. CPC A23J 3/227; A23J 3/16; A23L 29/272; A23L 33/105; A23L 33/115; A23L 33/145; A23L 33/16; A23L 33/15

(57) ABSTRACT

The present invention relates to a meat substitute hamburger comprising: 1 to 50 wt % of a plant protein; 0.01 to 5 wt % of a high acyl gellan gum; 5 to 20 wt % of a plant oil and/or fat; 0.001 to 5 wt % of a colorant; 0.01 to 5 wt % of a juiciness enhancer; 0.001 to 5 wt % of a nutrient; 0 to 5 wt % of a binder; and water up to 100 wt %.

### FIELD

The present invention relates to a meat substitute hamburger. According to another aspect the present invention relates to a method for the production of a meat substitute hamburger. Finally, the present invention relates to the use of the meat substitute hamburger.

### BACKGROUND OF THE INVENTION

Meat substitutes become abundantly available following the increasing need in the market for vegetarian products. Meat substitute hamburgers are developed that closely mimic the texture and taste of real meat hamburgers. Plant protein is the common ingredient in most meat substitute hamburgers. Challenges of using plant protein instead of animal protein is to provide a good texture that is perceived as a real meat hamburger, including a juicy mouthfeel. Therefore, there is a need in the art for meat substitute hamburgers that provide a good texture in combination with a juicy mouthfeel. Particularly there is a need in the art for meat substitute hamburgers with an improved hardness and firmness.

### DETAILED DESCRIPTION OF THE INVENTION

This object, amongst other objects is solved by providing a meat substitute hamburger according to the appended claims.

Specifically, the present invention relates to a meat substitute hamburger comprising:
1 to 50 wt % of a plant protein;
0.01 to 5 wt/o of a high acyl gellan gum;
5 to 20 wt % of a plant oil and/or fat;
0.001 to 5 wt % of a colorant;
0.01 to 5 wt % of a juiciness enhancer;
0.001 to 5 wt % of a nutrient
0 to 5 wt % of a binder; and/or
water up to 100 wt %.

The present inventors surprisingly found that a meat substitute hamburger according to the invention provides a good texture in combination with a juicy mouthfeel. Without being to be bound to any theory, it is expected that the high acyl gellan gum provides the beneficial texture resembling real meat hamburgers.

The term “meat substitute hamburger” or “meat analogue hamburger” as used herein means a non-meat based flattened, usually round shape serving of ground meat substitute ingredients. Alternatively the present meat substitute hamburger is meat substitute patty, or meat substitute hamburger patty. The term hamburger is not intended to include the bun, or sandwich, in which the present meat substitute hamburger is commonly served.

The term “high acyl gellan gum” as used herein is a polymer comprising various monosaccharides linked together to form a linear primary structure and the gum gels at temperatures of greater than 60 degrees centigrade. In some high acyl gellan gums, the gel temperature may be approximately 70 degrees centigrade or greater. In some high acyl gellan gums, the gel temperature may be approximately between 70 degrees centigrade and 80 degrees centigrade The properties of the high acyl gellan gum polymer may vary depending at least in part on its source, how it was processed, and/or the number and type of acyl groups present on the polymer.

Preferably, the present the high acyl gellan gum has a single gel setting temperature that is within the range of 70° C. to 90° C. The advantage of high acyl gellan gum is that it forms soft and flexible gels, beneficial in providing a good texture of a meat substitute hamburger, without introducing off flavors to the meat substitute hamburger.

Preferably, the present high acyl gellan gum has more than 40% acetyl and more than 45% glyceryl residual substitutions per repeating unit.

The term “colorant” as used herein relates to substances that provides a color to the meat substitute hamburger, or ingredients thereof.

The term “juiciness enhancer” as used in the present context means a substance suitable for providing juiciness or juicy mouthfeel to the present meat substitute hamburger. Juicy mouthfeel is a sensory attribute as perceived by a consumer.

The term “nutrient” as used herein relates to a substances that provide nutritional value to the present meat substitute hamburger. Such as vitamins, minerals, trace elements and antioxidants for example.

In a preferred embodiment, the present plant protein comprises a texturized plant protein.

Preferably, the present meat substitute hamburger comprises:
1 to 50 wt % of a texturized plant protein;
1 to 20 wt % of a plant protein;
0.01 to 5 wt % of a high acyl gellan gum;
to 20 wt % of a plant oil and/or fat;
0.001 to 5 wt % of a colorant;
0.01 to 5 wt % of a juiciness enhancer;
0.001 to 5 wt % of a nutrient
0 to 5 wt % of a binder; and/or
water up to 100 wt %.

The term “textured plant protein” as used herein refers to plant extract material, preferably derived from legumes, cereals or oilseeds. For example, the legume may be soy or pea. The cereals can be wheat. The oilseeds can be sunflower or canola seeds. In one embodiment, the textured protein is made by extrusion. This can cause a change in the structure of the protein which results in a fibrous, spongy matrix, similar in texture to meat. The textured protein can be dehydrated or non-dehydrated. In its dehydrated form, textured protein can have a shelf life of longer than a year, but will spoil within several days after being hydrated. In its flaked form, it can be used similarly to ground meat.

In a preferred embodiment, the present juiciness enhancer is a yeast autolysate. Without wishing to be bound by any theory, it is expected that the presence of yeast cell walls, or disrupted yeast cell walls, provide an additional juicy mouthfeel to the present meat substitute hamburger.

“Autolyzed yeast” or “yeast autolysate” has been known for many years as a source of protein, peptides, amino acids, fats, minerals and B-vitamins. The Food Chemical Codex defines Autolysed Yeast as follows: “Autolysed Yeast is the concentrated, not extracted, partially soluble digest obtained from food-grade yeasts. Solubilisation is accomplished by enzyme hydrolysis or autolysis of yeast cells. Autolysed Yeast contains both soluble and insoluble components derived from the whole yeast cell”.

A “yeast autolysate” is not the same as a “yeast extract” as can be deduced from the same Food Chemical Codex which defines a “yeast extract” as follows: “Yeast Extract comprises the water soluble components of the yeast cell, the composition of which is primarily amino-acids, peptides, carbohydrates and salts. Yeast Extract is produced through the hydrolysis of peptide bonds by the naturally occurring enzymes present in edible yeast or by the addition of food-grade enzymes”.

The yeast autolysate therefore differs from the “yeast extract” because the yeast autolysate, in addition to all the interesting components present in yeast extracts, also contains interesting components like β-glucans, mannoproteins and the yeast lipid fraction, present in the yeast cell wall. Another major difference is that the yeast autolysate contains a lot of insoluble components whereas the yeast extracts only comprise the water-soluble components of the yeast cell. A yeast extract contains more than 95% soluble material and usually up to 100%. In the production process of the yeast extract, the insoluble are removed by a suitable solid liquid separation whereas in the production of the yeast autolysate this step is lacking. The entire autolysate is subjected to a concentrating/drying step.

Yeast autolysates are known from WO2009/007424, which is incorporated by reference herein.

In a preferred embodiment, the present yeast autolysate comprises 5′-ribonucleotides. The term “5′-ribonucleotides” refers to the total amount of 5′-monophosphate ribonucleotides formed during RNA degradation: 5′-monophosphate guanine (5′-GMP), 5′-monophosphate uracil (5′-UMP), 5′-monophosphate cytosine (5′-CMP), 5′-monophosphate adenine (5′-AMP), where 5′-AMP may be partially or completely converted into 5′-monophosphate inosine (5′-IMP). Preferably, the present yeast autolysate comprises at least 0.75% w/w 5′-GMP on sodium chloride free dry matter, more preferably at least 1% w/w 5′-GMP, more preferably at least 1.5% w/w 5′-GMP more preferably at least 2% w/w and most preferably, the yeast autolysate comprises at least 2.5% w/w 5′-GMP on sodium chloride free dry matter. Weight percentage calculations of the 5′-ribonucleotides are based on the disodium salt heptahydrate thereof unless otherwise specified. All percentages are calculated on sodium chloride free dry matter. The phrase “sodium chloride free dry matter” refers to the fact that for the calculation of the weight percentage the weight of any sodium chloride present is excluded from the yeast autolysate. The measurement of sodium chloride in the composition and the above-mentioned calculation can be performed by methods known to those skilled in the art.

Due to the constitution of RNA, 5′-UMP, 5′-CMP and 5′-AMP will also be present, but these nucleotides do not contribute significantly to taste or flavour enhancement. When 5′-AMP is transformed into 5′-IMP, typically by adenylic deaminase, the autolysate will comprises 5′-IMP, which contributes to flavour enhancement. Therefore, yeast autolysates containing 5′-IMP are also encompassed. Preferably, the present yeast autolysate comprises at least 0.75% w/w 5′-IMP on sodium chloride free dry matter, more preferably at least 1% w/w 5′-IMP, more preferably at least 1.5% w/w 5′-IMP, more preferably at least 2% w/w 5′-IMP and most preferably, the yeast autolysate comprises at least 2.5% w/w 5′-IMP on sodium chloride free dry matter. It will be understood by the skilled person, that it is highly preferred that the yeast autolysate of the invention comprises both 5′-GMP and 5′-IMP in the concentrations given above.

The present yeast autolysate may further comprise salt, preferably sodium chloride. Preferably, the yeast autolysate comprises a ≥5% and ≤50% w/w sodium chloride. More preferably, the yeast autolysate at least 10%, more preferably at least 20%, more preferably at least 30%, more preferably between 35 and 45%, most preferably 40%—all w/w. Preferably, the present yeast autolysate comprises ≤50% sodium chloride (w/w).

Alternatively, the present juiciness enhancer is cucumber juice and/or melon juice. Or the present juiciness enhancer is cucumber extract and/or melon extract.

Preferably, the present juiciness enhancer comprises the present yeast autolysate and a cucumber extract or the present yeast autolysate and a melon extract.

In a preferred embodiment, the present meat substitute hamburger comprises a binder, preferably 0.01 to 5 wt % of a binder.

The term “binder” or “binding agent” as used herein relates to a substance for holding together particles and/or fibers in a cohesive mass. It is an edible substance that in the final product is used to trap components of the foodstuff with a matrix for the purpose of forming a cohesive product and/or for thickening the product. Binding agents of the invention may contribute to a smoother product texture, add body to a product, help retain moisture and/or assist in maintaining cohesive product shape; for example by aiding particles to agglomerate.

The binder can be an isolated plant protein (e.g., a RuBisCO, an albumin, a gluten, a conglycinin, or mixtures thereof). The denaturation temperature of the binder can be between about 40 degrees centigrade and about 80 degrees centigrade. The binder can be a carbohydrate based gel. The carbohydrate based gel can contain methylcellulose or hydroxypropylmethyl cellulose. The binder can be egg albumin or collagen.

In a more preferred embodiment the present binder is chosen from the group consisting of methylcellulose, egg white, wheat gluten, calcium-alginate gels and starch based binders.

In another preferred embodiment, the present binder comprises 0.1 wt % to 10 wt % potato fiber and 0.3 wt % to 10 wt % plant protein, and wherein not less than 30 wt % of the dietary fiber is soluble.

The present plant oil and/or fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the oil is algal oil.

In a preferred embodiment, the present plant oil is sunflower oil and/or the present plant fat is coconut fat.

In a preferred embodiment, the present texturized plant protein is texturized soy protein or is texturized pea protein.

In a further preferred embodiment, the present plant protein is a soy protein concentrate or a soy protein isolate. Alternatively the present plant protein is pea protein, canola protein or is sunflower protein.

More preferably a pea protein isolate or concentrate. More preferably a canola protein isolate or concentrate. More preferably a sunflower protein isolate or concentrate.

Alternatively, the present plant protein and texturized plant protein are soy protein.

Alternatively, the present plant protein and texturized plant protein are pea protein.

Alternatively, the present plant protein and texturized plant protein are canola protein.

In a preferred embodiment, the present colorant comprises or is beet root or beet root powder. The advantage of using beet root is that a meaty like color is provided to the meat substitute hamburger, without introducing off flavors to the meat substitute hamburger.

The present colorant can also be or comprise a carotenoid. Preferably, the carotenoid is chosen from the group consisting of α- or β-carotene, 8′-apo-β-carotenal, 8′-apo-β-carotenoic acid esters such as the ethyl ester, canthaxanthin, astaxanthin, astaxanthin esters, lycopene, lutein, zeaxan-thin or crocetin and their derivatives.

In a preferred embodiment, the present nutrient comprises vitamins and/or minerals, preferably vitamins chosen from the group consisting of B2, B3, B6 and B12 and/or preferably minerals chosen from the group consisting of iron, selenium and zinc. The advantage of adding these nutrients is that the present meat substitute hamburger more closely resembles the nutritional value of a real meat hamburger, without introducing off flavors to the meat substitute hamburger.

In a preferred embodiment the present meat substitute hamburger comprises a flavor or flavor agent, or flavor precursor. Examples of flavors can be yeast extracts or process flavours. More preferably the present meat substitute hamburger comprises 0.001 to 5 wt % of a flavor.

Preferably, the present meat substitute hamburger comprises salt, preferable NaCl. The amount of salt is preferably within the range of 0.001 to 5 wt % of the present meat substitute hamburger.

According to another aspect, the present invention relates to a method for the production of a meat substitute hamburger as described herein, comprising a step of mixing the present ingredients until a homogenous dough is obtained, shaping the dough into a hamburger, and heating the hamburgers to a temperature higher than 120° C. for more than 5 minutes to produce the meat substitute hamburger. Preferably the heating step is to a temperature within the range of 140° C. to 200° C. and/or for a time period of 10 to 15 minutes.

Preferably, the present process also comprises a step of cooling the homogenous dough to a temperature within the range of 1 to 10° C. for a period of 10 to 300 minutes. Subsequently hamburgers can be shaped from the cooled homogenous dough. Alternatively, the present shaped hamburgers are cooled to a temperature within the range of 1 to 10° C. for a period of 10 to 300 minutes before heating the hamburgers to a temperature higher than 120° C. for more than 5 minutes to produce the meat substitute hamburger.

Finally, it is advantageous to freeze the meat substitute hamburgers to provide frozen meat substitute hamburgers.

According to yet another aspect, the present invention relates to the use of the hamburgers as described herein, in a food item. For example in ready to eat meals such as in ready to eat hamburgers sandwiches.

The present invention is further illustrated using the examples below.

### EXAMPLES

### Example 1 Hamburger Recipe

The ingredients as shown in table 1 were prepared as follows. Water was added to texturized soy and mixed until hydrated. Caramelized sugar, beet root powder, vitamins & minerals, salt and yeast autolysates where dry mixed separately and added to the hydrated soy. The remaining ingredients where added to the mixture which was subsequently hand mixed until homogenous appearance. The homogenous dough was chilled for 1 hour in the fridge. Hamburgers where subsequently shaped by hand. The hamburgers where cooked in an oven at 160° C., for 12 minutes. The hamburgers where frozen in the freezer for at least 3 nights before use.

TABLE 1

| Ingredient | Test 1 (Weight %) | Comparative (weight %) |
|---|---|---|
| Soy texturized vegetable protein (Roquette) | 20 | 20 |
| Caramelized sugar | 1 | 1 |
| Beet root powder | 0.5 | 0.5 |
| High acyl gellan gum (DSM, Gellaneer ™ HD) | 0.5 | 0.0 |
| Cold binding starch (Paselli WA4) | 0.0 | 3.0 |
| Methylcellulose | 1 | 1 |
| Sunflower oil | 8 | 8 |
| Soy protein concentrate (Roquette) | 3 | 3 |
| Vitamines & minerals (B2, B3, B6, B12, iron, | 0.05 | 0.05 |
| selenium, zinc) | | |
| Salt | 1 | 1 |
| Yeast autolysates (according to WO2009007424) | 1 | 1 |
| Coconut fat | 5 | 5 |
| Water | 58.95 | 56.45 |

### Example 2 Results of Pan Fried Hamburger

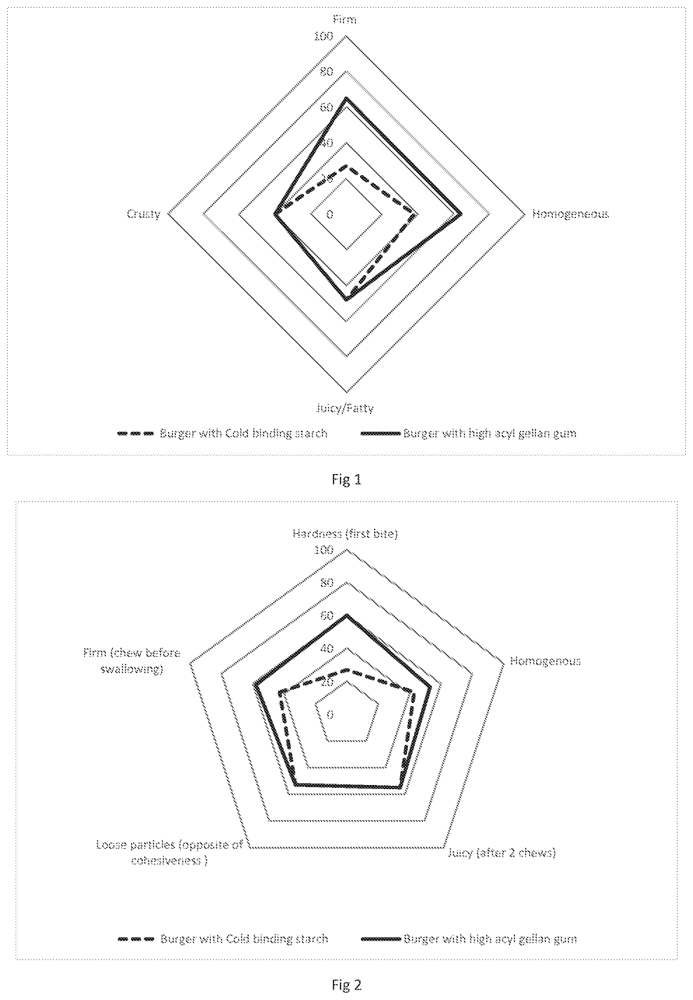

The hamburgers prepared in example 1 were defrosted and fried in a pan in sunflower oil for 4 minutes per side until uniformly light golden. The hamburgers were tested by 8 panelists. The hamburgers provided a firm texture and provided a juicy mouthfeel. The texture was analysed by cutting the hamburgers. The results are shown in FIG. 1, showing an increase in firmness and more homogenous. The texture was also analysed by tasting. The results are shown in FIG. 2. The hardness (first bite) and the firmness (chew before swallowing) increased, and the hamburgers where perceived as more homogenous.

1. A meat substitute hamburger comprising:
1 to 50 wt % of a plant protein;
0.01 to 5 wt % of a high acyl gellan gum;
5 to 20 wt % of a plant oil and/or fat;
0.001 to 5 wt % of a colorant;
0.01 to 5 wt % of a juiciness enhancer;
0.001 to 5 wt % of a nutrient;
0 to 5 wt % of a binder; and
water up to 100 wt %.

2. The meat substitute hamburger according to claim 1, wherein the juiciness enhancer is a yeast autolysate.

3. The meat substitute hamburger according to claim 1, wherein the high acyl gellan gum has a single gel setting temperature that is within the range of 70° C. to 90° C.

4. The meat substitute according to claim 1, wherein the high acyl gellan gum has more than 40% acetyl and more than 45% glyceryl residual substitutions per repeating unit.

5. The meat substitute hamburger according to claim 1, wherein the plant protein comprises a soy protein concentrate.

6. The meat substitute hamburger according to claim 1, wherein the plant oil is sunflower oil and/or wherein the plant fat is coconut fat.

7. The meat substitute hamburger according to claim 1, wherein the binder is selected from the group consisting of methylcellulose, egg white, wheat gluten, calcium-alginate gels and starch based binders.

8. The meat substitute hamburger according to claim 1, wherein the binder comprises 0.1 wt % to 10 wt % potato fiber and 0.3 wt % to 10 wt % plant protein, and wherein not less than 30 wt % of the dietary fiber is soluble.

9. The meat substitute hamburger according to claim 1, wherein the colorant is beet root.

10. The meat substitute hamburger according to claim 1, wherein the plant protein comprises texturized plant protein.

11. The meat substitute hamburger according to claim 10, wherein the texturized plant protein is texturized soy protein.

12. The meat substitute hamburger according to claim 1, wherein the nutrient comprises both a vitamin and a mineral.

13. The meat substitute hamburger according to claim 1, further comprising a flavor.

14. A method for the production of a meat substitute hamburger according to claim 1, comprising mixing ingredients until a homogenous dough is obtained, shaping the dough into a hamburger, and heating the hamburger to a temperature higher than 120° C. for more than 5 minutes to produce the meat substitute hamburger.

15. A food item comprising the meat substitute hamburger according to claim 1.

16. The meat substitute hamburger according to claim 12, wherein the vitamin is selected from the group consisting of B2, B3, B6 and B12, and wherein the mineral is selected from the group consisting of iron, selenium, and zinc.
